(19) United States
(12) Patent Application Publication
(10) Pub. No.: US 2019/0065964 A1
(43) Pub. Date: Feb. 28, 2019

(54) METHOD AND APPARATUS FOR LOAD VALUE PREDICTION

(71) Applicant: QUALCOMM Incorporated, San Diego, CA (US)

(72) Inventors: Rami Mohammad A. AL SHEIKH, Morrisville, NC (US); Derek HOWER, Durham, NC (US)

(21) Appl. No.: 15/691,741

(22) Filed: Aug. 30, 2017

(51) Int. Cl. G06N 5/02; G06N 7/00; G06N 99/00; G06F 9/32

(52) U.S. Cl. CPC G06N 5/02; G06N 7/005; G06F 9/30043; G06F 9/32; G06N 99/005

(57) ABSTRACT

A method and apparatus for predicting instruction load values in a processor. While a program is executing the processor is used to train predictors in order to predict load values. In particular 4 differing kinds of predictors are trained. The four predictors are the Last Value Predictor (LVP) which captures loads that encounter very few values, the Stride Address Predictor (SAP) which captures loads based on stride (offset) addresses, a Content Address Predictor (CAP) which captures load addresses that are non-stride and the Context Value Predictor (CVP) which captures load values in a particular context that are non-stride. Training methods and the use of such predictors are disclosed.

### FIELD OF DISCLOSURE

Disclosed aspects are directed to processing systems. More specifically, exemplary aspects are directed to speculative load value prediction within a processing system.

### BACKGROUND

A processing system may face a variety of challenges in delivering increased performance Two of the prominent challenges are the desire for increasing throughput (i.e. faster program execution) and lower power consumption. Lower power consumption is particularly desirable for mobile devices which may depend on battery power for their operation.

A major factor in increasing throughput is the load to use delay, which is the delay encountered when a load dependent instruction (or simply, “load”) fetches data from a memory hierarchy and provides it to instructions dependent on the load. A load dependent instruction is one that requires data from memory to execute. Loads may be critical for several reasons. Loads typically may represent 20% to 40% of the executed instructions in a computer program. Load execution latency, which is the time a load has to wait for data, varies depending on where the data is located in the memory hierarchy. For example if the data to be loaded is present in a cache the access may be relatively quick. If the data to be loaded is not in cache (cache miss) load dependent instructions have to wait longer for the data and the processor's finite resources may get clogged resulting in lower performance and power wasting processor stalls. Accordingly, there is a need in the art for processor instructions to have quicker access to data.

### SUMMARY

Exemplary aspects of the teachings herein are directed to systems and method for data speculation. In one illustrative aspect, disclosed systems and methods are directed to predicting instruction load values in a processor. The method, in one illustrative aspect of the teaching herein comprises, training a Last Value Predictor (LVP), training a Stride Address Predictor (SAP), training a Context Based Address Predictor (CAP), training a Context Value Predictor (CVP), examining the trained accuracy of the predictors value prediction, and using the predictor having the highest trained accuracy of value prediction to predict load data.

In another exemplary aspect of the teachings herein a method of using an address predictor is disclosed. The method comprises using the address predictor to predict an address, comparing a trained accuracy of the address predictor to a threshold, and determining whether to read a cache address based on the comparison.

In another exemplary aspect of the teachings herein, aspects of the invention are directed to an apparatus comprising a processor coupled to a memory the processor configured to train LV, SA, CA, and CV predictors to predict load values, and load value addresses.

### BRIEF DESCRIPTION OF THE DRAWINGS

The accompanying drawings are presented to aid in the description of aspects of the invention and are provided solely for illustration of the aspects and not limitation thereof.

FIG. 1 is a graphical illustration of a design comprising four cascaded predictors.

FIG. 2A is a flow chart depicting a training scheme for a cascaded multi predictor design as illustrated in FIG. 1.

FIG. 2B is a flow chart depicting a serial training scheme for a cascaded multi predictor design as illustrated in FIG. 1.

FIG. 3A is a flow chart for selective prediction training, that may be used with a serial or a parallel training scheme, according to an aspect of the invention.

FIG. 3B is a flow chart using multiple thresholds for the address predictors CAP (Content Address Predictor) and SAP (Stride Address Predictor).

FIG. 4 depicts an exemplary computing device in which an aspect of the disclosure may be advantageously employed.

### DETAILED DESCRIPTION

Aspects of the inventive teachings herein are disclosed in the following description and related drawings directed to specific aspects. Alternate aspects may be devised without departing from the scope of the inventive concepts herein. Additionally, well-known elements of the environment may not be described in detail or may be omitted so as not to obscure the relevant details of the inventive teachings herein.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

An easy way to speed up a loads' execution is to simply increase the size of a first level cache (i.e. L1 cache) thereby making more high speed memory available to hold data values. However, simply increasing the size of the first level cache will increase the size of the cache on the semiconductor chip on which the cache resides and may increase power consumption as cache circuits typically may be power hungry circuits.

Fortunately there are other methods, besides simply increasing the cache size, to speed up load execution for example Data Prefetching and Data Value Prediction.

Data Prefetching attempts to speed up loads' execution by prefetching or bringing the data expected to be referenced by the load instruction into higher cache levels (e.g., L1 cache). This way, a load dependent instruction can execute much faster since it will have fast access to the needed data.

Data Value Prediction attempts to speed up the execution of load dependent instructions by predicting the value that will be produced by a particular load instruction, and allowing the dependent instructions to execute using the predicted value. Later, when the load actually executes, it can confirm or disconfirm that prediction. If the prediction was incorrect recovery actions are performed.

The term “load instruction,” as used herein refers broadly to any instruction that causes a value to be fetched from any level of memory.

A significant fraction of load instructions in a set of program instructions may exhibit the following properties, which are considered in exemplary aspects:
1. Loads that produce a small number of distinct values,
2. Loads that sequence through stride (constant offset) addresses,
3. Loads that encounter far less number of distinct addresses than distinct values,
4. Loads that encounter far less number of distinct values than distinct addresses.

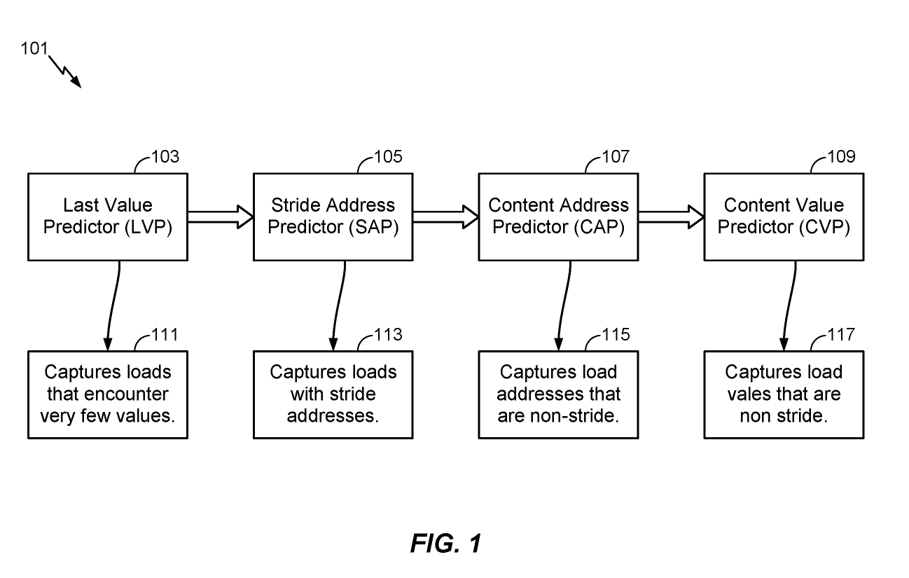

FIG. 1 is a graphical illustration of a design 101 comprising four cascaded predictors. Predictor 103 is a Last Value Predictor (LVP), predictor 105 is a Stride Address Predictor (SAP), predictor 107 is a Content Address Predictor (CAP), and predictor 109 is a Context Value Predictor (CVP).

Predictor 103, the Last Value Predictor (LVP), captures loads that encounter very few values 111 and provides the value 111 as a predicted value for a load instruction. The LVP may record, as the value 111, a value that was accessed by an instruction at a particular program counter location. Various implementations are possible for the LVP. For example, the LVP may: record any number of values and then find the most repeated value; the LVP may eliminate recorded values that appear only sporadically; or the LVP may only save the last load value and use that the last load value as the value 111. A program may be executed to record a history of values that were fetched by an instruction at a particular program counter location in order to train the predictor. The process of recording a history of values, which may be address and/or data values, to make a prediction is referred to as training the predictor.

To establish the efficacy of a predictor the training may include a tally of predictor accuracy. In one aspect the predictor accuracy may use a MPKI (Missed Predictions per thousand (Kilo) Instructions) metric. A predictor may be trained as the program is executing, or the training may have occurred from previous executions of the program or both.

Predictor 105, the Stride Address Predictor (SAP), does not predict load values directly, instead it provides a predicted memory address by adding the stride (offset) to a previous address 113. The stride may be determined during the training process, though a predetermined stride may also be used. The value at the address plus the offset may then be fetched and used, or placed in a cache for quick access.

Predictor 107 is the Content Address Predictor (CAP), which predicts a non-stride load address 115. To predict the memory address the CAP may use the program counter (PC) of a load instruction and other information (e.g., global branch history, branch path history, load path history . . . etc.), to predict the memory address of the load. The load path history may be the program counters history of previous load instructions. The predicted memory address can be used to probe the data cache early for quick access later.

The Context Value Predictor (CVP 109) learns the load value that follows a particular context and then predicts a value when that context reoccurs. The CVP captures load values that are non-stride 117. To illustrate one example, a CVP captures the branch history preceding the load instruction of interest and correlates it with a value obtained when the load instruction of interest is executed. The context may contain data points such as subroutine depth, processor flags, etc. The CVP may actually use the Content Address Predictor (CAP) address prediction to predict load data value. Additionally these type of data points, or others, may be used with other predictors and may depend on the type of implementation desired and the effectiveness and efficiency of adding such data.

As can be readily seen from the above description, value predictors LVP and CVP predict load values directly, while address predictors SAP and CAP predict load values indirectly by attempting to predict the location of the load value, then using the predicted location to predict or fetch the value at that location. Accordingly, some efficiency could be achieved by storing the address predicted by SAP and CAP in the same memory location and some efficiency could be achieved by storing the predicted load value of all the predictors in a single memory location. However this efficiency may not be available during the training process, unless the predictors are trained serially, i.e. one at a time.

In some aspects, all predictors may be continually trained and run (i e making predictions) while the program is executing. While this method may be effective it has several drawbacks which may preclude its use. Training all predictors continuously would continually require power and memory for all of the predictors. This can be a waste of processor resources, particularly if one or more of the predictors is continually trained and not actually used for prediction, in which case the memory used to continually train the predictor would be of no use, and consume power and generate heat. Additionally the predictor accuracy from a previous program execution—may be used. However this method also has drawbacks, which may argue against its use. As an example, the current execution of the program may be very different than a previous execution of the same program so that the accuracy of each predictor may be different than a previous execution of the program. Additionally, a nonvolatile method of recording the load instruction and associated predictor may be required to remember which predictors were used in the previous program execution. Accordingly, a more selective training scheme may be used in some aspects, as described below.

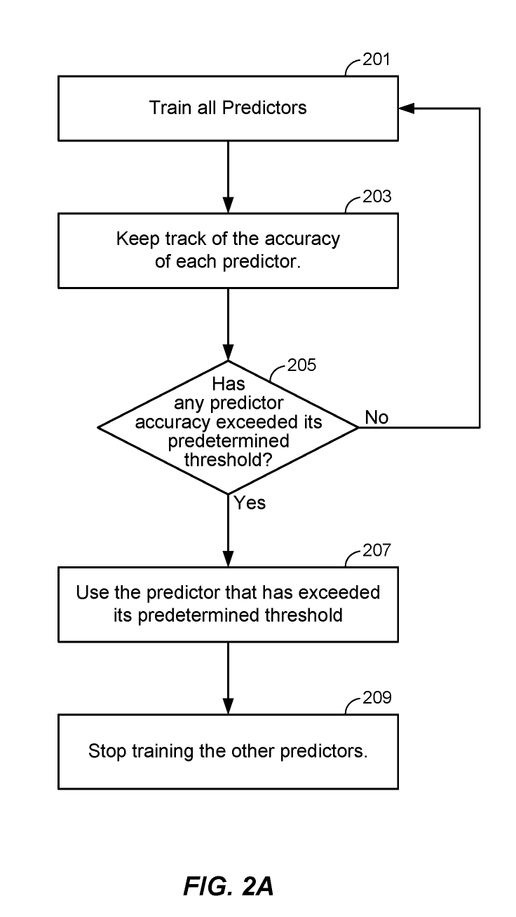

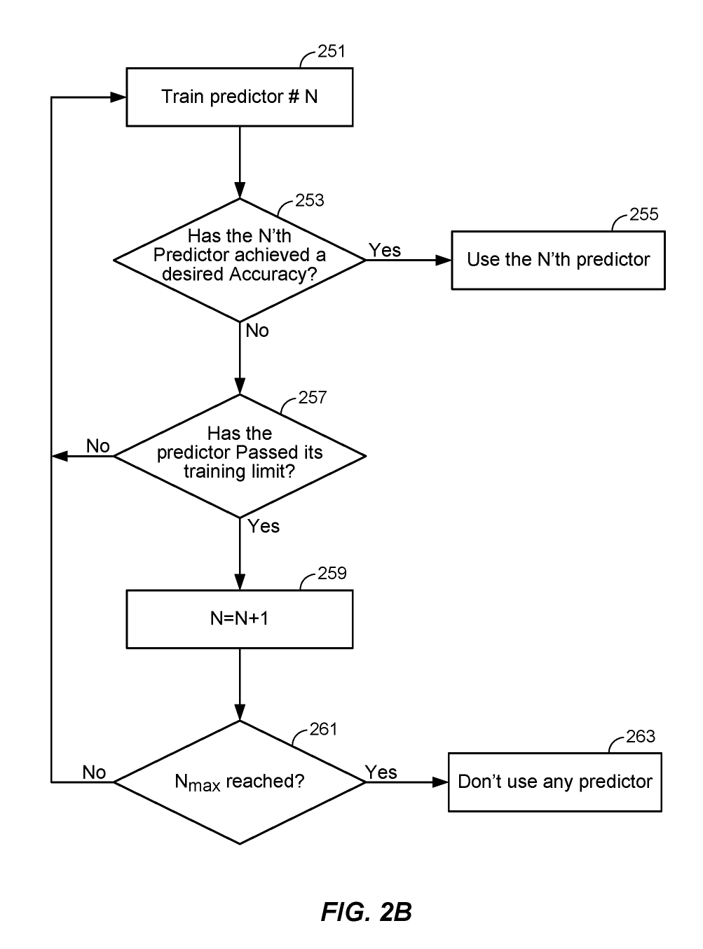

FIG. 2A is a flow chart depicting a training scheme for a cascaded multi predictor design 101 as illustrated in FIG. 1.

In Block 201, the first step of the process, all predictors are trained. In one aspect the predictors are all trained simultaneously, though many training variations, as will be discussed later herein, are possible. In Block 203, as part of the training of the predictors, a running tally of the accuracy of each predictor may be maintained. In Decision Block 205 the accuracy of each predictor is evaluated against a predetermined threshold. If none of predictors have passed its acceptable threshold level for prediction accuracy, then control is transferred back to Block 201 where the process of training all the predictors continues. All of the predictors may have the same threshold, although there are reasons to assign differing thresholds to the predictors. One reason to assign differing thresholds to the various predictors is so that the overhead associated with each predictor, which may be very different for each type of predictor could be accounted for. Having different (i.e. scaled) thresholds may be used to account for the overhead of using different predictors, the time delay associated with the use of each predictors, power consumed for each predictor to make a prediction, a combination of such factors, or the like. For example the Last Value Predictor (LVP), which may predict with little overhead, is likely to consume less resources than a Context Value Predictor (CVP) which, in one aspect, may actually use the Content Address Predictor (CAP) to predict the value at the predicted given address, thus making the value prediction a several step process. If one of the predictors has exceeded the associated predetermined threshold control passes to Block 207 where the predictor that has passed its predetermined threshold is used for prediction, then control passes to Block 209. In Block 209 the process of training the predictors is halted. A number of variations are possible for the functioning of Block 209. For the purpose of clarification and elucidation, but not limitation several of the variations are discussed hereinafter. For example the selected predictor may continue to be trained or a running tally of the MPKI (Missed Predictions per Thousand Instructions) may be kept while the training process is halted for other predictors, then if the accuracy of that predictor falls below a certain level the process as illustrated in FIG. 2A may be repeated. Additionally Block 209 may stop the training for a period of time (training timeout) then begin the training process again to determine if the predictor accuracy has changed. If the prediction accuracy is repeated, Block 209 may change the training timeout to a longer time, or if the prediction accuracy has changed unfavorably the timeout period may be shortened.

FIG. 2B is a flow chart depicting a serial training scheme for a cascaded multi predictor design as illustrated in FIG. 1. In Block 251 Predictor N is trained. For illustrative purposes N is a single predictor though it need not be. For the first pass through the flowchart, N=1 to designate the first predictor. Control then passes to Block 253. In block 253 accuracy of predictor N is compared to a predetermined threshold. If predictor N exceeds the predetermined threshold then control passes to Block 255, otherwise control passes to decision block 257. In Block 255, since predictor N exceeds the predetermined threshold that predictor will be used for load prediction. Predictor N may be used from that point on or the process, the process may be re-initiated as the implementation dictates in a similar fashion to FIG. 2B block 209. In Block 257 how long the training process for predictor N has been going on (e.g. the number of iterations of the training process) is examined. If the predictor has reached a maximum training iterations value without achieving a desired MPKI (Misses Per Thousand Instructions) then control passes to Block 259 where N is incremented to try to train the next predictor. Control then passes to decision Block 261. In Decision Block 261 N is examined to see if it has not exceeded a maximum value. If other predictors remain to be trained and examined for acceptable accuracy (N<=maximum number of predictors), and control then passes to Block 251 to continue the training process. If none of the predictors have achieved the desired predetermined threshold the process continues in block 201. If none of the predictors are accurate enough to merit their use (N>maximum number of predictors) control is passed to Block 263 where the training process is terminated. Of course the training process may be reinitiated; illustratively block 263 may utilize the same mechanisms to re-initiated training as was described in reference to Block 209.

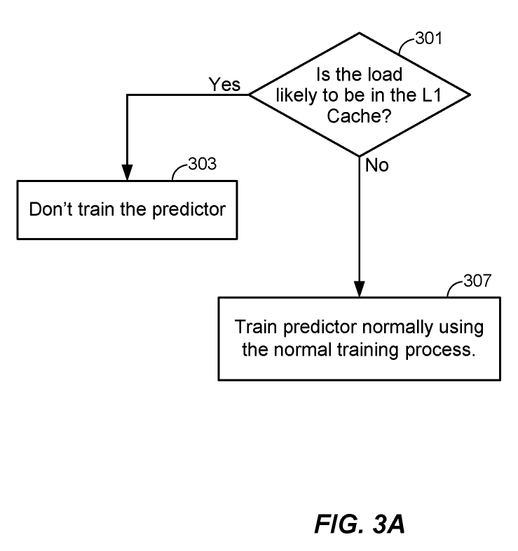

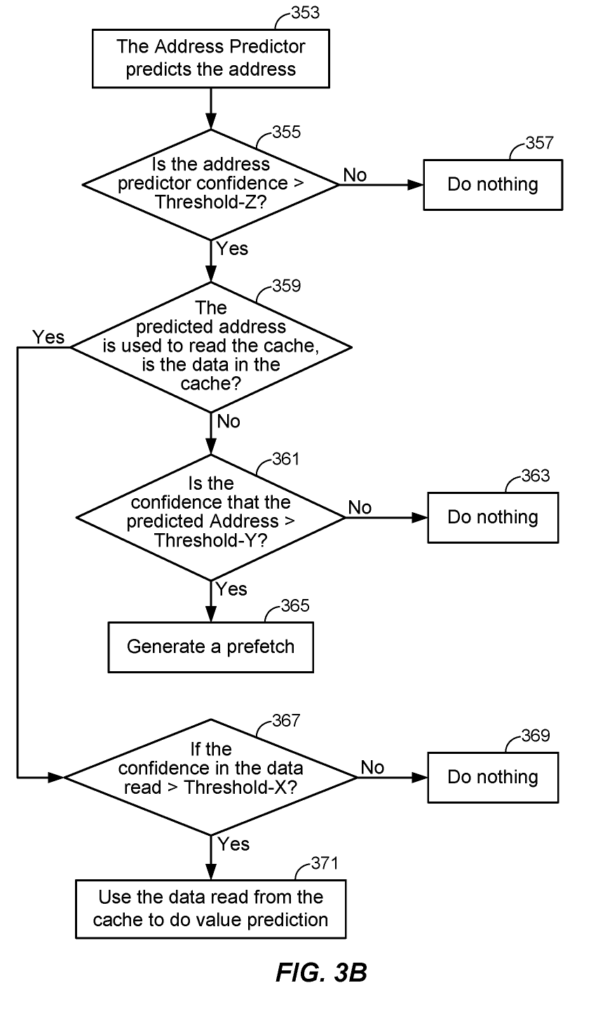

FIG. 3A is a flow chart for selective prediction training, that may be used with a serial or a parallel training scheme, according to an aspect of the invention.

In FIG. 3A block 301 may be entered when the processor executes a load data type operation. In Block 301 the load data type operation is evaluated to determine if the actual load data is likely to be in a L1 cache.

In an example of the use of the teachings herein the training process is only initiated when the load value is not likely to be in the L1 cache. An L1 cache is commonly a fast memory integrated on the same chip as the processor, so a processor will have quick access to data values that reside in the L1 cache. If a data value is likely to reside in the L1 Cache it may not be worthwhile to go through the overhead of attempting to predict the load value, and secondarily it may not be worthwhile to train predictors to predict values that are likely to reside in the L1 cache.

Block 301 can evaluate the likelihood that a data value may reside in the L1 cache using a variety of criteria well known in the art.

As non-limiting examples a data value might likely reside in the L1 Cache if the data value sought has a history of residing in the L1 Cache, or a data value might likely reside in the L1 Cache if recent processor fetches have all hit (been present) in the L1 cache.

If the load data is likely to be in the L1 Cache then control is transferred to block 303 where the predictor is not trained and the process may end there. If the load data is not likely to be in the L1 cache, control is transferred to block 307 and the predictor will be trained according to a normal training process.

FIG. 3B is a flow chart illustrating the use of confidence thresholds for the address predictors CAP and SAP. A confidence threshold is merely a guess, based on training statistics; of how likely it is that a prediction will be accurate. So if we determine our confidence level is, as an example, 60% then the odds are 60% a predicted value will be prediction will be accurate. For the purpose of clarity and illustration the following threshold levels are defined. These definitions will be used to help illustrate the workings of the flow chart depicted in FIG. 3B:

1. Threshold-X is a confidence threshold for value prediction. It is the confidence level that the data read from the predicted address in the cache is correct.

2. Threshold-Y this is the confidence level for prefetching data. It is the confidence level that the predicted address such that it will be worthwhile to generate a prefetch to bring the data to the cache.

3. Threshold-Z is a combination of Threshold-X and Threshold-Y. Typically may be set by a designer familiar with the computer architecture in which aspects of the present inventive teachings are used. Threshold-Z may be determined in a variety of ways. It may be simply the minimum of Threshold-X and Threshold-Y, it may be an average, a weighted average, a proportional relationship, or a variety of other mathematical constructs such as may be beneficial to the system architecture and implementation aspects of the particular system in which it is used.

In FIG. 3B block 353 may be entered when an address predictor is about to be used for a prediction. In Block 353 the Address predictor (SAP or CAP) makes an address prediction. In block 355 the confidence of the predicted address is examined. If the confidence in the predicted address is greater than Threshold-Z then the predicted address is used to read the cache (exemplarily a L1-Cache) in block 359, otherwise control is transferred to block 367 and nothing more is done. The value of the predicted address is read in block 359, to determine if the data is in the cache. If the data is not in the cache control passes to block 361 where the confidence that the predicted address is accurate will be is examined. If the confidence in the predicted address is less than or equal to Threshold-Y control is transferred to block 363 and nothing is done. If the confidence in the predicted address is greater than Threshold-Y control is transferred to block 365 where a prefetch is generated, to read the predicted address from memory into the cache and the process ends. If, in block 359, the data is in the cache then control is transferred to decision block 367. If confidence in the data read from the cache is greater than Threshold-X control is transferred to block 371 and the data read from the cache is used to do value prediction and the process ends. If, in block 357, the confidence in the data read is less than or equal to Threshold-X control is transferred to block 369 and the process ends.

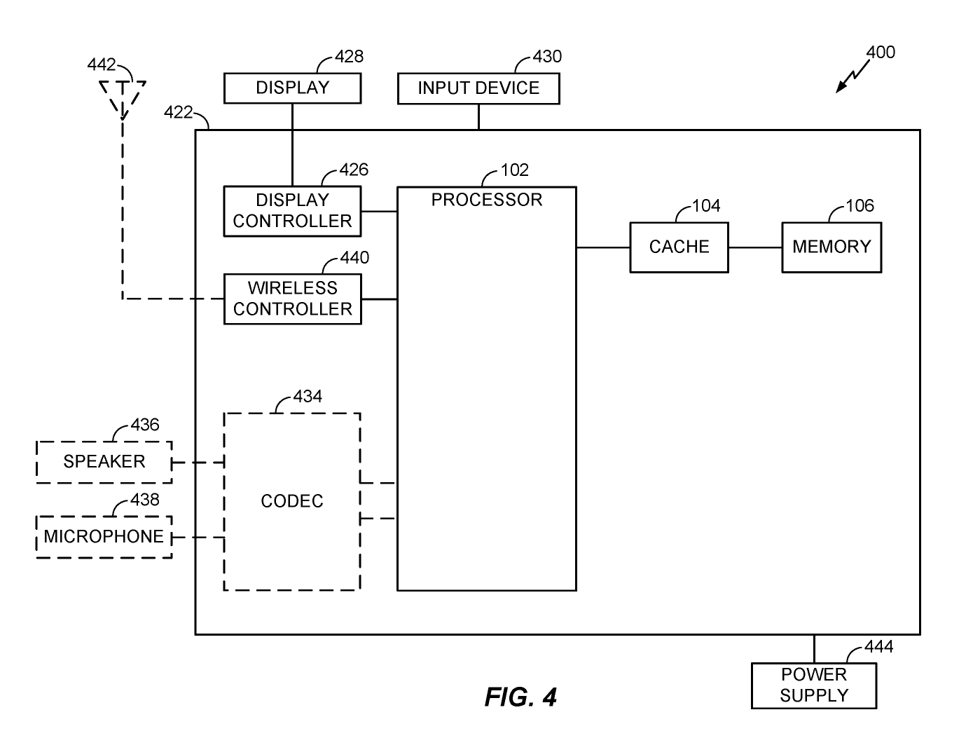

FIG. 4 depicts an exemplary computing device in which an aspect of the disclosure may be advantageously employed. In FIG. 4, processor 102 is exemplarily shown to be coupled to memory 106 with cache 104 disposed between processor 102 and memory 106, but it will be understood that other configurations known in the art may also be supported by computing device 400. FIG. 4 also shows display controller 426 that is coupled to processor 102 and to display 428. In some cases, computing device 400 may be used for wireless communication and FIG. 4 also shows optional blocks in dashed lines, such as coder/decoder (CODEC) 434 (e.g., an audio and/or voice CODEC) coupled to processor 102 and speaker 436 and microphone 438 can be coupled to CODEC 434; and wireless antenna 442 coupled to wireless controller 440 which is coupled to processor 102. Where one or more of these optional blocks are present, in a particular aspect, processor 102, display controller 426, memory 110, and wireless controller 440 are included in a system-in-package or system-on-chip device 422.

Accordingly, a particular aspect, input device 430 and power supply 444 are coupled to computing device 400, Moreover, in a particular aspect, as illustrated in FIG. 4, where one or more optional blocks are present, display 428, input device 430, speaker 436, microphone 438, wireless antenna 442, and power supply 444 may be external to computing device 400. Additionally, each of display 428, input device 430, speaker 436, microphone 438, wireless antenna 442, and power supply 444 can be coupled to aa computing device 400 through an interface or a controller.

It should be noted that although FIG. 4 generally depicts a computing device, processor 102, cache 104 and memory 106, may also be integrated into a set top box, a server, a music player, a video player, an entertainment unit, a navigation device, a personal digital assistant (PDA), a fixed location data unit, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer readable media embodying a method for predicting a load value. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of predicting a load value, the method comprising:
training at least two of a Last Value Predictor (LVP) wherein the LVP is configured to predict the load value based on a value of a previous loads, a Stride Address Predictor (SAP) wherein the SAP is configured to predict a load address based on values of previous load addresses and an offset; a Context Based Address Predictor (CAP) wherein the CAP is configured to predict the load address based on a context of a previous loads, and a Context Value Predictor (CVP) wherein the CVP is configured to predict the load value based on the context of a previous load;
comparing a trained accuracy of at least two predictors' value prediction to identify a predictor having a highest trained accuracy;
using the predictor having the highest trained accuracy to predict the load value.

2. The method of claim 1 wherein examining the accuracy of all four predictors further comprises comparing the accuracy of each predictor to a corresponding prespecified value.

3. The method of claim 1 wherein the predictors are trained sequentially and using the predictor having the highest trained accuracy further comprises selecting the predictor that first achieves an acceptable level of accuracy.

4. The method of claim 3 where the predictors are trained in an order according to a previous accuracy order of the predictors.

5. The method of claim 1 wherein the training of the predictors is continuous, and the predictor used to predict the data load value is selected according to the running accuracy of the predictors.

6. The method of claim 1 wherein the training is terminated when one of the predictors exceeds a predetermined prediction accuracy, the one predictor that exceeds the predetermined prediction accuracy is used to predict load values.

7. The method of claim 1 where training further comprises:
examining a load dependent instruction in to determine if the data to be loaded is likely to be found in a L1 cache; and
if the data is likely to be found in the L1 Cache forgoing the training of all the predictors.

8. The method of claim 2 further comprising:
wherein when the accuracy of a predictor reaches corresponding prespecified accuracy value, training is terminated with respect to the other predictors.

9. The method of claim 8 further comprising:
wherein when the predictor that reached a corresponding prespecified accuracy value falls below the corresponding prespecified accuracy training of at least one more predictor is resumed.

10. A method of using an address predictor comprising:
using the address predictor to predict an address;
comparing a trained accuracy of the address predictor to a threshold; and
determining whether to read a cache address based on the comparison.

11. The method of claim 10 wherein determining whether to read a cache address based on the comparison comprises:
using the predicted address to read data from the cache; and
deciding whether to do value prediction, using data read from the cache, based on a Threshold-X, wherein Threshold-X is a predicted accuracy of the data read from the cache.

12. The method of claim 10 further comprising:
deciding whether to generate an address prefetch request based on Threshold-Y wherein Threshold-Y is a predicted accuracy of the address to be prefetched if the data is not in the cache.

13. The method of claim 11 further comprising:
determining a Threshold-Z by mathematically combining Threshold-X and Threshold-Y; and
determining whether to read the cache based on Threshold-Z.

14. The method of claim 13 wherein Threshold-Z is determined as the minimum of Threshold-X and Threshold-Y.

15. The predictor training method of claim 1 wherein when the method is employed a first time the trained accuracy of the predictors are all below an acceptable level so that no prediction is used, but another attempt to train the predictors is attempted a second time after a timeout period.

16. An apparatus comprising a processor coupled to a memory the processor configured to train at least two of a Last Value Predictor (LVP), a Stride Address Predictor (SAP), a Context Based Address Predictor (CAP), and a Context Value Predictor (CVP)

17. The apparatus of claim 17 wherein at least one of the LVP, the SAP, the CAP or the CVP is configured to be used to predict instruction load values.

18. The apparatus of claim 17 wherein the CAP and the SAP address prediction are stored in a common memory location.

19. The apparatus of claim 17 wherein the CVP and LVP predictors' data values are stored in a common memory location.

20. A method of predicting a load value, the method comprising:
means for training at least two of a Last Value Predictor (LVP) wherein the LVP is configured to predict the load value based on a value of a previous loads, a Stride Address Predictor (SAP) wherein the SAP is configured to predict a load address based on values of previous load addresses and an offset; a Context Based Address Predictor (CAP) wherein the CAP is configured to predict the load address based on a context of a previous loads, and a Context Value Predictor (CVP) wherein the CVP is configured to predict the load value based on the context of a previous load;
means for comparing a trained accuracy of at least two predictors' value prediction to identify a predictor having a highest trained accuracy;
means for using the predictor having the highest trained accuracy to predict the load value.
